(19) United States
(12) Patent Application Publication
(10) Pub. No.: US 2009/0040439 A1
(43) Pub. Date: Feb. 12, 2009

(54) LIQUID CRYSTAL DISPLAY APPARATUS

(75) Inventor: Tsuyoshi Ohyama, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/180,923

(22) Filed: Jul. 28, 2008

(30) Foreign Application Priority Data
Aug. 6, 2007 (JP) 2007-203791

(51) Int. Cl. G02F 1/1335; G02F 1/13363

(52) U.S. Cl. 349/106; 349/117; 349/114

(57) ABSTRACT

Disclosed herein is a liquid crystal display apparatus, including: first and second substrates having first and second polarizing plates, respectively; a liquid crystal layer sandwiched between the first and second substrates; an electrode provided on the first substrate for applying an electric field parallel to a face of the first substrate to the liquid crystal layer to drive liquid crystal molecules of the liquid crystal layer; a pixel having a reflective display portion and a transmissive display portion; and a phase difference plate provided on a face of the second substrate adjacent the liquid crystal layer such that no phase difference is generated in a front direction in the transmissive display portion but a phase difference is generated in the reflective display portion.

### CROSS REFERENCES TO RELATED APPLICATIONS

The present invention contains subject matter related to Japanese Patent Application JP 2007-203791 filed in the Japan Patent Office on Aug. 6, 2007, the entire contents of which being incorporated herein by reference.

### BACKGROUND OF THE INVENTION

1. Field of the Invention

This invention relates to a liquid crystal display apparatus and can be applied to a liquid crystal display apparatus, for example, of the FFS (Fringe Field Switching) mode or the IPS (In-Plane Switching) mode.

2. Description of the Related Art

In recent years, a transmission type liquid crystal display apparatus of the in-plane switching (IPS) mode is used in a monitor apparatus and so forth. The transmission type liquid crystal display apparatus of the IPS mode includes a pair of substrates, a liquid crystal layer sandwiched by the substrates, and a pair of polarizing plates of crossed nicols arrangement between which the substrates are arranged. In the transmission type liquid crystal display apparatus of the IPS mode, orientation films are formed such that, in a state wherein no electric field is applied, the orientation axis of liquid crystal molecules is directed in parallel to the transmission axis of one of the polarizing plates. Then, if an electric field parallel to the planes of the substrates is applied, then the liquid crystal molecules are rotated in parallel to the planes of the substrates.

Consequently, in the transmission type liquid crystal display apparatus of the IPS mode, incoming light transmitted through the incoming side polarizing plate in the state wherein no electric field is applied is transmitted through the liquid crystal layer without being provided with a phase difference. Then, the transmitted light is intercepted by the outgoing side polarizing plate to form normally black display. On the other hand, when an electric field is applied to rotate the orientation axis of the liquid crystal molecules, the incoming light which is transmitted through the liquid crystal layer is provided with a phase difference, and goes out from the outgoing side polarizing plate by a light amount corresponding to the applied voltage. It is known that the transmission type liquid crystal display apparatus of the IPS mode can assure a wide view angle characteristic and exhibits a high response speed.

Meanwhile, in portable information apparatus such as portable telephone sets and electronic still cameras in recent years, a liquid crystal display apparatus of the transflective type of the ECB (Electrically Controlled Birefringence) mode is used. The transflective liquid crystal display apparatus includes pixels each having a reflective display portion and a transmissive display portion therein and can exhibit a high contrast under various environments such as the open air in fine weather and the interior of a dark room. Accordingly, the transflective liquid crystal display apparatus has desirable characteristics for a display apparatus of a portable type information apparatus. However, the liquid crystal display apparatus of the ECB mode has a drawback in that it has a narrow angle of view because liquid crystal molecules are switched in a vertical direction.

Accordingly, a transflective liquid crystal display apparatus of the IPS mode which has a superior view angle characteristic is demanded. However, a transflective liquid crystal display apparatus of the IPS mode displays black by making the transmission axis of one of polarizing plates disposed in crossed nicols arrangement and the orientation axis of the liquid crystal molecules coincide with each other as described above. Therefore, if merely a reflecting plate is provided to configure a reflective display portion as in the transflective liquid crystal display apparatus of the ECB mode, when no electric field is applied, the reflective display portion displays white. Consequently, it is difficult to configure a transflective display apparatus of the IPS mode by merely providing a reflecting plate.

A method of configuring a transflective liquid crystal display apparatus of the IPS mode wherein a phase difference plate for λ/2 is provided in a reflective display portion is disclosed in Japanese Patent Laid-Open No. 2006-171376 (hereinafter referred to as Patent Document 1).

Further, in a liquid crystal display apparatus of the type described, liquid crystal molecules are oriented to a predetermined direction by an orientation film. A method of setting a polarization face to be used for exposure of an orientation film to set the orientation direction is disclosed in Japanese Patent Laid-Open No. Hei 5-232473 (hereinafter referred to as Patent Document 2).

However, if the method disclosed in Patent Document 1 is adopted, then it is necessary to develop liquid crystal of the UV curing property so as to remain only at a predetermined portion, and to this end, development by organic solvent is demanded. Therefore, the method described has a drawback that in it is insufficient for practical use in terms of the mass productivity.

### SUMMARY OF THE INVENTION

Therefore, it is demanded to provide a liquid crystal display apparatus of the IPS mode or the like which is simple in configuration while assuring a wide view angle characteristic.

To this end, according to embodiments of the present invention, a phase difference plate having a transmissive display portion which does not generate a phase difference in a front direction is provided on a face of a CF substrate adjacent a liquid crystal layer.

According to an embodiment of the present invention, there is provided a liquid crystal display apparatus including first and second substrates having first and second polarizing plates, respectively, a liquid crystal layer sandwiched between the first and second substrates, an electrode provided on the first substrate for applying an electric field parallel to a face of the first substrate to the liquid crystal layer to drive liquid crystal molecules of the liquid crystal layer, a pixel having a reflective display portion and a transmissive display portion, and a phase difference plate provided on a face of the second substrate adjacent the liquid crystal layer such that no phase difference is generated in a front direction in the transmissive display portion but a phase difference is generated in the reflective display portion.

According to another embodiment of the present invention, there is provided a liquid crystal display apparatus including first and second substrates having first and second polarizing plates, respectively, a liquid crystal layer sandwiched between the first and second substrates, a pixel having a reflective display portion and a transmissive display portion, and a phase difference plate provided on a face of the second substrate adjacent the liquid crystal layer such that no phase difference is generated in a front direction in the transmissive display portion but a phase difference is generated in the reflective display portion, the transmissive display portion being configured such that, from an electrode provided on the first substrate, an electric field parallel to a face of the substrates is applied to the liquid crystal layer to drive liquid crystal molecules of the liquid crystal layer, the reflective display portion being driven in an electrically controlled birefringence mode through a pixel electrode provided on the first substrate and a common electrode provided on the second substrate.

With the liquid crystal display apparatus, transflective display can be implemented in the IPS mode or the like by a simple configuration while a wide view angle characteristic is assured.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic sectional view showing a liquid crystal display panel applied to a liquid crystal display apparatus according to a first embodiment of the present invention;

FIG. 2 is a schematic view illustrating a characteristic of the liquid crystal display panel of FIG. 1 when no electric field is applied;

FIG. 3 is a similar view but illustrating a characteristic of the liquid crystal display panel of FIG. 1 when an electric field is applied;

FIG. 4 is a diagrammatic view illustrating operation of a phase difference plate of the liquid crystal display panel of FIG. 1;

FIG. 5 is a flow chart illustrating a production process of the phase difference plate of the liquid crystal display panel of FIG. 1;

FIG. 6 is a schematic sectional view showing a liquid crystal display panel applied to a liquid crystal display apparatus according to a second embodiment of the present invention;

FIG. 7 is a schematic view showing an optical configuration of the liquid crystal display panel of FIG. 6;

FIG. 8 is a diagrammatic view illustrating a view angle characteristic where a phase difference plate and a C plate are not provided;

FIG. 9 is a diagrammatic view illustrating a view angle characteristic of the liquid crystal display panel of FIG. 6;

FIG. 10 is a flow chart illustrating a production process of a phase difference plate used in a liquid crystal display panel according to a third embodiment of the present invention;

FIG. 11 is a flow chart illustrating a production process of a phase difference plate used in a liquid crystal display panel according to a fourth embodiment of the present invention;

FIG. 12 is a diagrammatic view illustrating operation of a phase difference plate used in a liquid crystal display panel according to a fifth embodiment of the present invention;

FIG. 13 is a schematic perspective view showing an optical configuration of the liquid crystal display panel according to the fifth embodiment of the present invention; and

FIG. 14 is a schematic sectional view showing a liquid crystal display panel applied to a liquid crystal display apparatus according to a different embodiment of the present invention.

### DETAILED DESCRIPTION OF THE PREFERRED EMBODIMENTS

### First Embodiment

### (1) Configuration of the Embodiment

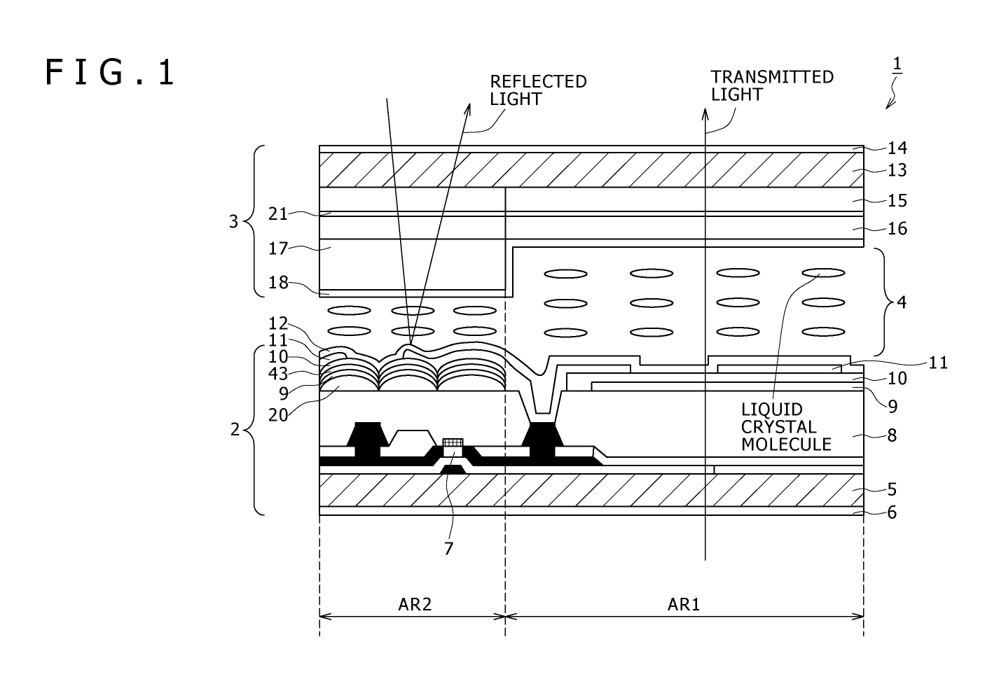

FIG. 1 shows part of a liquid crystal display panel applied to a liquid crystal display apparatus of a first embodiment of the present invention. Referring to FIG. 1, the liquid crystal display apparatus is incorporated in a portable information apparatus such as a portable telephone set or a personal digital assistant. A backlight apparatus not shown is disposed on the back of the liquid crystal display panel 1. The liquid crystal display panel 1 shown is of the transflective type wherein one pixel has a transmissive display portion AR1 and a reflective display portion AR2. The liquid crystal display panel 1 includes a TFT substrate 2, a CF substrate 3, and a liquid crystal layer 4 of nematic liquid crystal sandwiched by the TFT substrate 2 and the CF substrate 3.

The TFT substrate 2 includes a transparent insulating substrate 5 formed from a glass substrate or the like, and a polarizing plate 6 disposed on a face of the transparent insulating substrate 5 remote from the liquid crystal layer 4. Meanwhile, TFTs (Thin Film Transistors) 7, wiring line patterns for the TFTs 7 and so forth are provided on a face of the transparent insulating substrate 5 adjacent the liquid crystal layer 4, and an insulating film 8 is provided on the TFTs 7 and so forth. A common electrode 9 is provided on the insulating film 8, and pixel electrodes 11 are provided on the common electrode 9 in an insulated relationship by an insulating film 10 such that, when a voltage is applied to the pixel electrodes 11, the pixel electrodes 11 apply an electric field parallel to the plane of the TFT substrate 2 to the liquid crystal layer 4. It is to be noted that, in the reflective display portion AR2, a scattering layer 20 is formed on the insulating film 8, and the common electrode 9 is provided on the scattering layer 20. Further, in the reflective display portion AR2, a reflecting electrode 43 formed by deposition of a metal material such as aluminum or silver and serving also as a reflecting layer is formed on the common electrode 9, and the insulating film 10 and a pixel electrode 11 are successively provided on the reflecting electrode 43. The TFT substrate 2 further includes an orientation film 12 provided as an upper layer on the pixel electrode 11.

Meanwhile, the CF substrate 3 includes a transparent insulating substrate 13 formed from a glass substrate or the like and a polarizing plate 14 disposed on a face of the transparent insulating substrate 13 remote from the liquid crystal layer 4. The polarizing plate 14 is disposed in a direction such that the absorption axis thereof extends perpendicularly to that of the polarizing plate 6 of the TFT substrate 2. The CF substrate 3 further includes a color filter 15, an overcoat layer not shown and a phase difference plate 16 successively provided on a face of the transparent insulating substrate 13 adjacent the liquid crystal layer 4. The phase difference plate 16 provides, in the transmissive display portion AR1, no phase difference only to transmitted light in the front direction of the liquid crystal display panel 1, but provides, in the reflective display portion AR2, a predetermined phase difference to the transmitted light. More particularly, the phase difference plate 16 provides a phase difference of λ/2 to the transmitted light. The CF substrate 3 further includes, in the reflective display portion AR2, an offset 17 provided on the phase difference plate 16 and formed from an insulating film. The CF substrate 3 further includes an orientation film 18 provided in the transmissive display portion AR1 and the reflective display portion AR2. The orientation film 18 has an orientation direction antiparallel to that of the orientation film 12 of the TFT substrate 2.

In the liquid crystal display panel 1, the gap in the transmissive display portion AR1 is set to λ/2, and the gap in the reflective display portion AR2 is set to λ/4 by the offset 17. Further, the liquid crystal display panel 1 is set such that, in a state wherein no electric field is applied, the absorption axis of the polarizing plate 6 or 14 and the orientation direction of the liquid crystal molecules extend in parallel to each other by the orientation films 12 and 18.

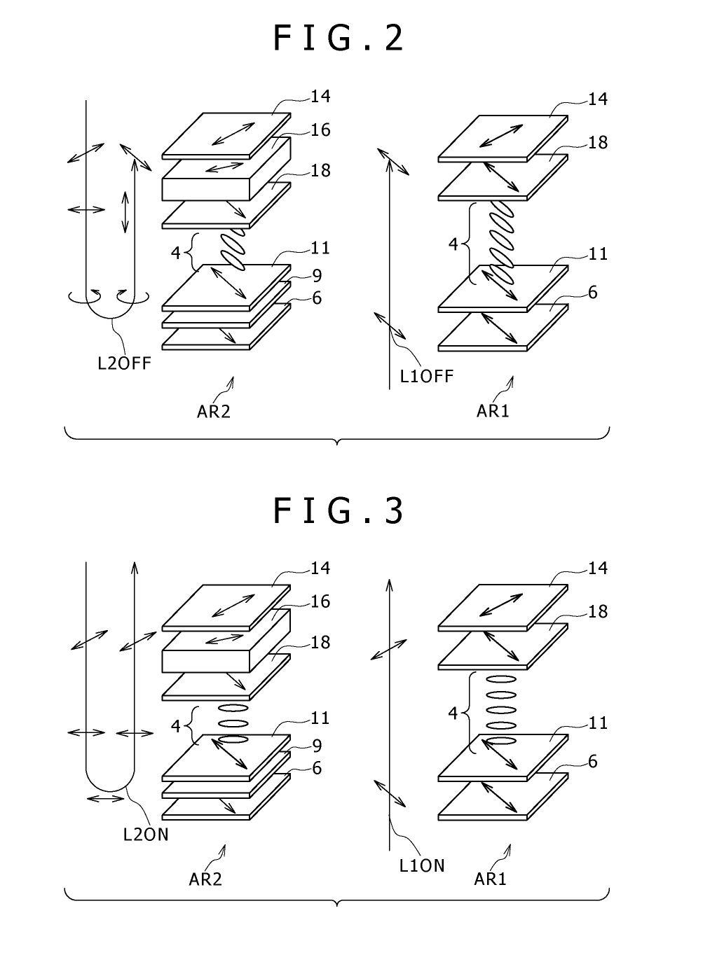

Consequently, in the liquid crystal display panel 1, as seen in FIG. 2, incoming light L1OFF transmitted through the polarizing plate 6 after it is emitted from the backlight apparatus in a state wherein no electric field is applied passes, in the transmissive display portion AR1, through the liquid crystal layer 4 without a phase difference provided thereto. This transmitted light is intercepted by the polarizing plate 14 of the CF substrate 3 thereby to form normally black display. Further, in the liquid crystal display panel 1 in a state wherein no electric field is applied, external light L20FF incoming through the polarizing plate 14 of the CF substrate 3 is provided, in the reflective display portion AR2, with a phase difference of λ/2 by the phase difference plate 16 so as to have a polarization plane rotated by 45 degrees. Thereafter, the external light L20FF is provided with a phase difference of λ/4 by the liquid crystal layer 4 and is reflected by the pixel electrode 11 due to circular polarization thereof. Further, the external light L20FF is provided with a phase difference of λ/4 by the liquid crystal layer 4 so as to become linearly polarized light having a phase displaced by 135 degrees from the transmission axis of the polarizing plate 14. Then, the external light L20FF is provided with a phase difference of λ/2 by the phase difference plate 16 and then comes into the polarizing plate 14. Consequently, in the liquid crystal display panel 1 in the state wherein no electric field is applied, transmitted light is intercepted by the polarizing plate 14 thereby to form normally black display. It is to be noted that, in FIGS. 2 and 3, the direction of the transmission axis and the orientation direction are each indicated by an arrow mark. Accordingly, in FIGS. 2 and 3, it can be seen that the direction of the transmission axis of the polarizing plate 6 of the TFT substrate 2 and the orientation axis of the liquid crystal molecules coincide with each other.

On the other hand, by a transverse electric field produced by application of a voltage between the pixel electrode 11 and the common electrode 9, the liquid crystal molecules are rotated in a plane parallel to the face of the substrate, and ideally, maximum luminance is exhibited when the liquid crystal molecules are rotated until the orientation direction thereof defines an angle of 45 degrees with respect to the transmission axis of the polarizing plates 6 and 14.

Consequently, as seen in FIG. 3, in the liquid crystal display panel 1, when an electric field for white display is applied, transmitted light L1ON of the polarizing plate 6 in the transmissive display portion AR1 is provided with a phase difference of λ/2 by the liquid crystal layer 4 thereby to rotate the polarization plane of the transmitted light L1ON by 90 degrees. Then, the transmitted light L1ON passes through the polarizing plate 14 and goes out thereby to form white display. Meanwhile, in the reflective display portion AR2, external light L20N incoming through the polarizing plate 14 of the CF substrate 3 passes through the liquid crystal layer 4 without being provided with any phase difference by application of a voltage for white display. Then, the external light L20N is reflected by the pixel electrode 11. The reflected light passes through the liquid crystal layer 4 without being provided with any phase difference and is then provided with a phase difference of λ/2 by the phase difference plate 16. Thereafter, the external light L20N enters the polarizing plate 14 depending upon the polarization plane of the transmission axis of the polarizing plate 14. Consequently, in the reflective display portion AR2, in white display, since the polarization plane of incoming light coincides with the polarization plane of the liquid crystal after the polarization plane of the incoming light is rotated by the phase difference plate 16, the incoming light is reflected as it is by the liquid crystal layer without being influenced by the phase difference thereby to provide white display.

Consequently, the liquid crystal display panel 1 displays various images by transflective display of the FFS type similar to the IPS type.

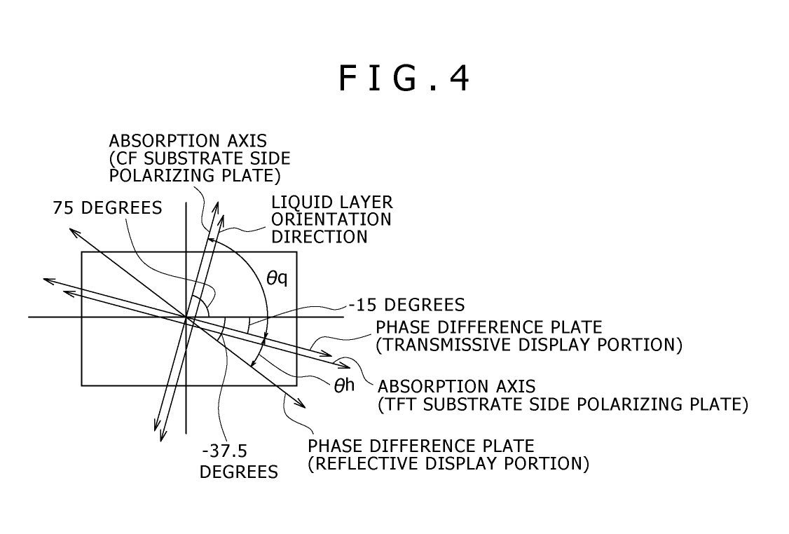

FIG. 4 illustrates operation of the phase difference plate 16 in contrast with FIG. 2 taking a case wherein no electric field is applied as an example. Where the angle between the absorption axis of the polarizing plate 6 of the TFT substrate 2 and the optical axis of the phase difference plate 16 is represented by θh and the angle between the absorption angle of the polarizing plate 6 of the TFT substrate 2 and the orientation direction of the liquid crystal molecules of the liquid crystal layer 4 is represented by θq, in order to obtain normally black display on the reflective display portion, it is necessary to satisfy a wideband condition of 2θh=±45 degrees+θq. Here, the angle θq is 0 degree or 90 degrees on the transmissive display portion. Accordingly, the angle θh is 22.5 degrees. On the other hand, on the transmissive display portion, it is necessary to set the angle θh so as to be 0 degree or 90 degrees. The phase difference plate 16 is formed so as to satisfy the relationship just described and besides function as an A plate of the positive type on the transmissive display portion.

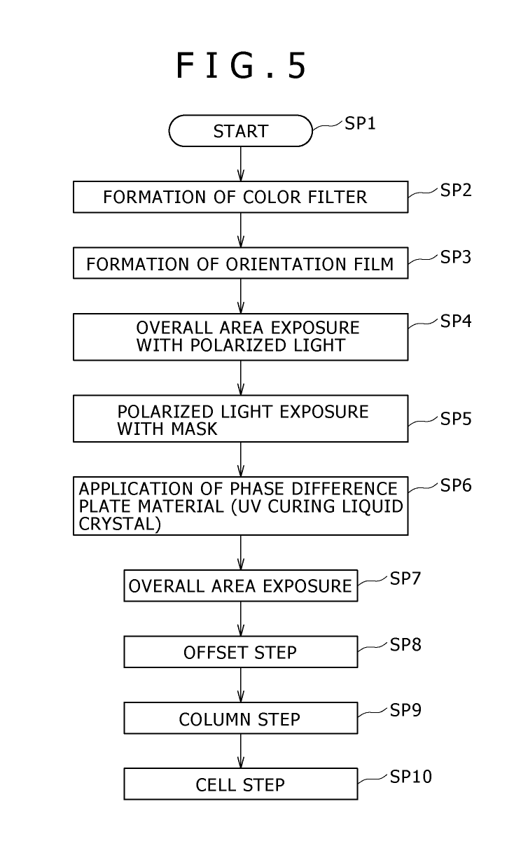

FIG. 5 illustrates a production procedure of the CF substrate 3 including the phase difference plate 16. Referring to FIG. 5, first at step SP2, the color filter 15 is formed on the transparent insulating substrate 13 and then an overcoat layer is formed such that the offset of the color filter 15 between the transmissive display portion AR1 and the reflective display portion AR2 is changed into a flattened state by the overcoat layer. Then at step SP3, an orientation film material is applied to the CF substrate 3. The orientation film material here is, for example, photosensitive polymer and is used for production of an orientation film for setting the direction of the optical axis of the phase difference plate 16.

Then at step SP4, the CF substrate 3 is exposed over the overall area of the orientation film material by ultraviolet rays having a polarization plane corresponding to the direction of the optical axis of the phase difference plate 16 in the transmissive display portion AR1 or the reflective display portion AR2. Further at step SP5, the orientation film material in the reflective display portion AR2 or the transmissive display portion AR1 is exposed with a mask by ultraviolet rays having a polarization plane corresponding to the direction of the optical axis of the phase difference plate 16 in the reflective display portion AR2 or the transmissive display portion AR1. Consequently, an orientation film 21 (refer to FIG. 1) having the orientation direction corresponding to the optical axis described above is formed on the phase difference plate 16 in the reflective display portion AR2 or the transmissive display portion AR1.

Then at step SP6, a phase difference plate material is applied to the CF substrate 3. The phase difference plate material here is liquid crystal polymer having photosensitivity, and, for example, a nematic liquid crystal material of the ultraviolet curing type is applied. Then at step SP7, ultraviolet rays are irradiated on the overall area of the phase difference plate material on the CF substrate 3 so as to be hardened thereby to produce the phase difference plate 16. The phase difference plate material may otherwise be hardened by a heating process in place of hardening by ultraviolet rays. Then at an offset step of step SP6, the offset 17 is formed on the CF substrate 3, and then the orientation film 18 is produced on the CF substrate 3. Then, at a column step of step SP9, a configuration for gap setting between the CF substrate 3 and the TFT substrate 2 is produced. Then at a cell step of step SP10, the CF substrate 3 is integrated with the TFT substrate 2.

### (2) Operation of the Embodiment

In the liquid crystal display panel 1 illustrated in FIG. 1 to 3 having the configuration described above, in the transmissive display portion AR1, emitted light of the backlight apparatus is transmitted through the polarizing plate 6 and comes in as incoming light of linearly polarized light. This incoming light is successively transmitted through the liquid crystal layer 4 and the phase difference plate 16 and enters the polarizing plate 14. Meanwhile, in the reflective display portion AR2, external light is transmitted through the polarizing plate 14 and enters in the form of linearly polarized light having a predetermined polarization plane. Then, the external light is successively transmitted through the phase difference plate 16 and the liquid crystal layer 4. Thereafter, the external light is reflected by the common electrode 9 and successively transmitted through the liquid crystal layer 4 and the phase difference plate 16, whereafter it enters the polarizing plate 14. In the optical paths of the incoming light from the backlight apparatus and the external light, liquid crystal molecules of the liquid crystal layer 4 are switched in a direction in the substrate plane in response to application of an electric field to the liquid crystal layer 4 by application of a voltage between the pixel electrode 11 and the common electrode 9 in accordance with the slit shape.

In the liquid crystal display panel 1 having such a configuration as described above, since the phase difference plate 16 having orientation directions set so that a phase difference may not be produced in the front direction at the transmissive display portion while a phase difference is produced at the reflection display portion is provided on the CF substrate 3 adjacent the liquid crystal layer 4, when no electric field is applied, both of the reflective display portion and the transmissive display portion can normally display black. However, if an electric field is applied, the both of the reflective display portion and the transmissive display portion can display white. Further, at the transmissive display portion, the view angle characteristic can be compensated for by the phase difference plate 16. Consequently, in the present embodiment, a transmissive liquid crystal display apparatus of a view angle characteristic by the FFS mode can be obtained. Further, in the phase difference plate 16, since a film thickness only sufficient to provide a phase difference of λ/2 to transmitted light is demanded at the reflective display portion AR2, it is possible to set the film thickness to several μm. Consequently, the thickness can be reduced from that of transflective liquid crystal of any other mode, and a transflective display apparatus can be implemented while the thickness is equal to that of the transmissive type display apparatus.

In particular, in the liquid crystal display panel 1, since the orientation films 12 and 18 are set such that, in the transmissive display portion AR1, when no electric field is applied, the direction of the absorption axis of one of the polarizing plates 6 and 14 arranged in crossed nicols arrangement and the orientation direction of the liquid crystal molecules coincide with each other, upon application of no electric field, it is possible for the liquid crystal layer 4 to provide no phase difference to incoming light in the form of linearly polarized light incoming past the polarizing plate 6. As a result, the incoming light can be intercepted by the polarizing plate 14 thereby to achieve normally black display. Further, since the phase difference plate 16 is set such that the direction of the transmission axis of the polarizing plate 6 or 14 is same as the direction of the optical axis, it is possible for the phase difference plate 16 to provide no phase difference to the transmitted light.

In contrast, upon display of white, the orientation direction of the liquid crystal layer 4 is rotated by an electric field generated by the pixel electrode 11 and the common electrode 9, and a phase difference of λ/2 by the liquid crystal layer 4 is provided to transmitted light. Consequently, outgoing light from the liquid crystal layer 4 is transmitted through the polarizing plate 14 due to the polarization plane of the transmission axis thereby to form white display.

In the meantime, in the reflective display portion AR2, a phase difference of λ/2 is provided to transmitted light by the phase difference plate 16. Consequently, when no electric field is applied, external light in the form of linearly polarized light passing through the polarizing plate 14 is provided with a phase difference of λ/2 by the phase difference plate 16 so that the polarization plane thereof is rotated by 45 degrees. Then, the external light is provided with a phase difference of λ/4 by the succeeding liquid crystal layer 4 so as to be converted into circularly polarized light and then comes to the common electrode 9 which functions as a reflecting electrode. Then, the circularly polarized light is reflected by the common electrode 9 to reverse the direction thereof and is then provided with a phase difference of λ/4 by the liquid crystal layer 4 so that it is converted into linearly polarized light whose phase is displaced by 135 degrees from the transmission axis of the polarizing plate 14. Then, the linearly polarized light is provided with a phase difference of λ/2 by the phase difference plate 16 so that the polarization plane thereof coincides with the direction of the absorption axis of the polarizing plate 14. Consequently, the linear polarized light is absorbed by the polarizing plate 14. As a result, in the liquid crystal display panel 1, when no electric field is applied, transmitted light of the phase difference plate 16 can be intercepted by the polarizing plate 14 thereby to form normally black display.

In contrast, upon application of an electric field for white display, in the reflective display portion AR2, since the orientation direction of the liquid crystal molecules of the liquid crystal layer 4 by an electric field generated by the pixel electrode 11 and the common electrode 9 is rotated by 45 degrees, transmitted light of the liquid crystal layer 4 is provided with no phase difference. Consequently, in this instance, external light in the form of linearly polarized light transmitted through the polarizing plate 14 is provided with a phase difference of λ/2 by the phase difference plate 16, whereupon the polarization plane rotates 45 degrees. Then, the external light is transmitted through the liquid crystal layer 4 and is reflected by the common electrode 9. Further, after the external light is transmitted through the liquid crystal layer 4, a phase difference of λ/2 is provided to the external light by the phase difference plate 16 so that the polarization plane of the external light becomes coincident with the transmission axis of the polarizing plate 14. Consequently, white display is obtained.

Consequently, with the liquid crystal display panel 1, since the phase difference provided by the phase difference plate 16 in the reflective display portion AR2 is λ/2, a transflective liquid crystal display apparatus can be configured in a simple configuration. In other words, in this instance, the orientation directions of liquid crystal molecules in the reflective display portion and the transmissive display portion can be made same as each other. Consequently, the configuration relating to the orientation of liquid crystal molecules can be simplified and the reliability thereof can be improved.

### (3) Effects of the Embodiment

According to the configuration described above, in the transflective liquid crystal display apparatus of the FFS mode, a phase difference plate which does not provide a phase difference in the front direction on a transmissive display portion is provided on the liquid crystal display side of a CF substrate. Therefore, while a wide view angle characteristic is assured, transflective display of the FFS mode, IPS mode or the like can be implemented with a simple configuration. Further, the thickness of the panel can be reduced. Further, where the transmissive display portion is applied to an information portable apparatus, high picture quality similar to that of a TV set can be obtained.

Further, since the phase difference of the reflective display portion of the phase difference plate is λ/2, the transflective liquid crystal display apparatus can be configured in a simple configuration.

Further, since the optical axis of the transmissive display portion of the phase difference plate is set to as to coincide with the transmission axis of one of polarizing plates, in the transmissive display portion, it is possible for the phase difference plate to particularly prevent a phase difference from appearing in the front direction. Consequently, a liquid crystal display apparatus of the FFS mode wherein the thickness of the panel can be reduced by a simple configuration while assuring a wide view angle characteristic.

Further, since, in the transmissive display portion, the optical axis of the phase difference plate is set to a direction perpendicular to the orientation direction of liquid crystal molecules when no electric field is applied, a sufficiently wide angle of view can be assured while a wideband configuration is satisfied.

### Second Embodiment

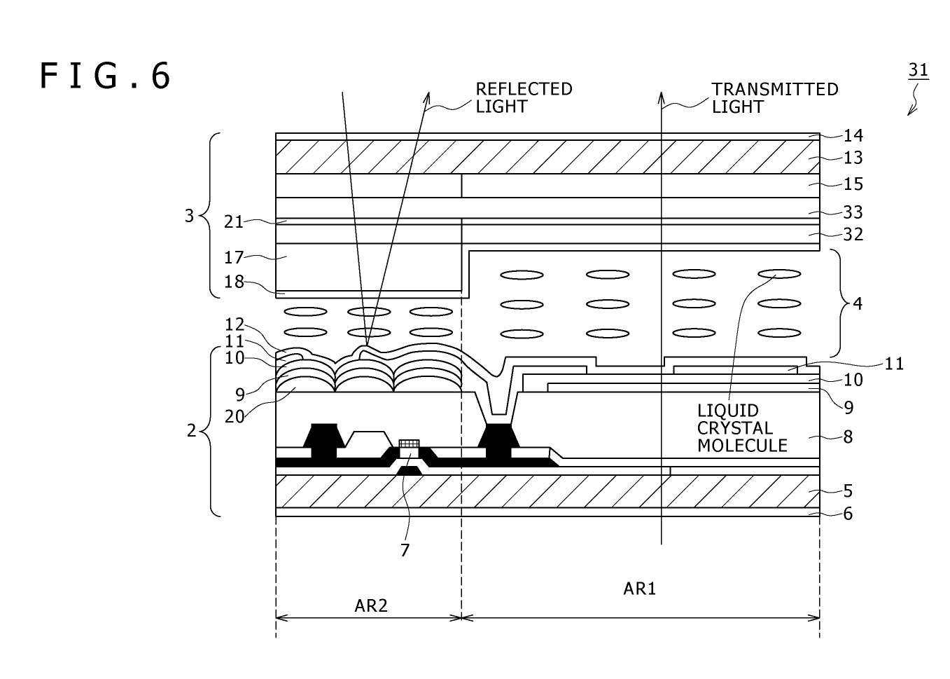

FIG. 6 shows a liquid crystal panel applied to a liquid crystal display apparatus of a second embodiment of the present invention. Referring to FIG. 6, the liquid crystal display panel 31 shown is configured similarly to the liquid crystal display panel 1 of the first embodiment except that a phase difference plate 32 is provided in place of the phase difference plate 16 and a C plate 33 of the positive type is provided between the phase difference plate 32 and the color filter 15.

In the present embodiment, the CF substrate 3 is set such that the thickness of the color filter 15 is different between the transmissive display portion AR1 and the reflective display portion AR2 so that the hues in the transmissive display portion AR1 and the reflective display portion AR2 may not differ from each other. Consequently, the CF substrate 3 provides an offset on the color filter 15 adjacent the liquid crystal layer 4.

In the CF substrate 3, a phase difference layer of homeotropic orientation is provided in Rth=−80 nm as an overcoat layer of the color filter 15 to provide the C plate 33. The liquid crystal display panel 31 has a view angle characteristic further widened by the C plate 33, and the offset of the color filter 15 is flattened by the C plate 33.

In order to produce the CF substrate 3, the phase difference plate 32 is produced first in a similar manner as in the first example, and then an insulating film is deposited, whereafter the insulating film in the transmissive display portion AR1 is selectively removed by etching to form the offset 17. After the phase difference plate 32 is produced first with a predetermined film thickness, the transmissive display portion is over-etched upon etching removal during production of the offset 17 thereby to set the film thickness in the transmissive display portion AR1 smaller than that in the reflective display portion AR2. Consequently, in the liquid crystal display panel 31, the film thickness of the phase difference plate 32 is optimized individually in the transmissive display portion AR1 and the reflective display portion AR2 and set to retardation values of 150 nm and 270 nm, respectively.

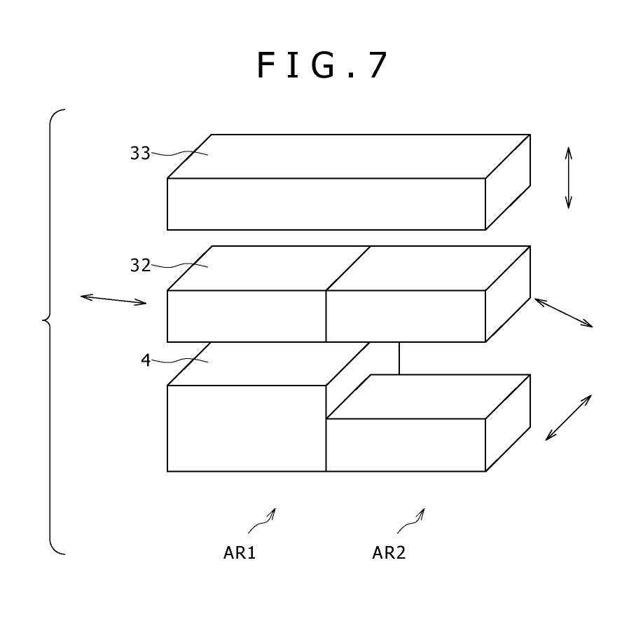

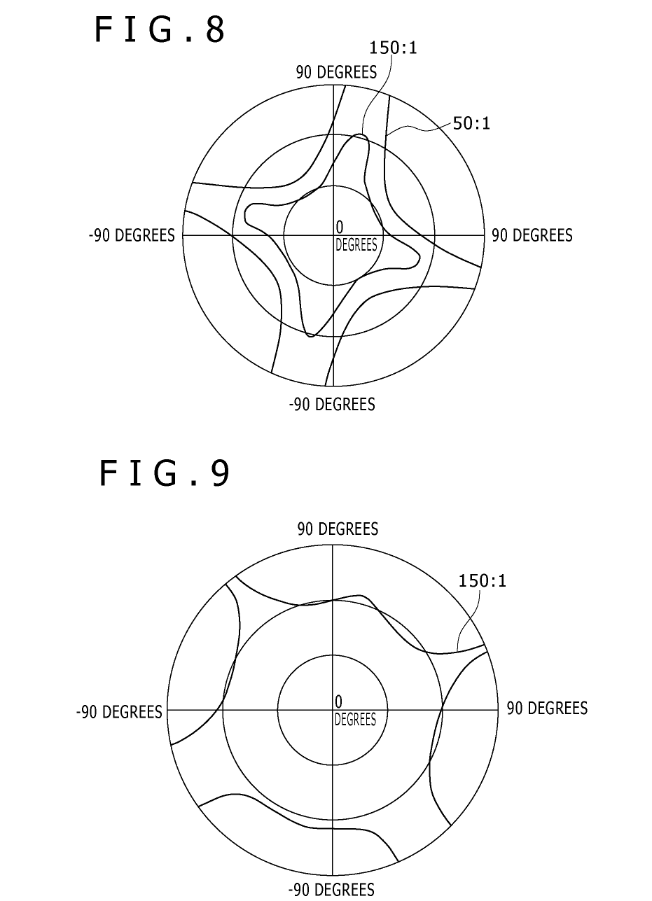

It is to be noted that FIG. 7 illustrates an optical configuration of the liquid crystal display panel 31 while each of the optical axis directions and orientation directions is indicated by an arrow mark. As apparently seen from FIG. 7, the C plate 33 is configured such that no phase difference is produced in the front direction of the liquid crystal display panel 31. Meanwhile, FIG. 8 illustrates a characteristic curve representative of the contrast ratio where the phase difference plate 32 and the C plate 33 are not disposed, and FIG. 9 illustrates a characteristic curve of the liquid crystal display panel of the present embodiment. As seen from FIG. 8, where the phase difference plate 32 and the C plate 33 are not disposed, a view angle characteristic of a contrast ratio of 150:1 can be assured only within a range of 60 degrees in the maximum from the front direction. On the other hand, as seen in FIG. 9, with the liquid crystal display panel 31 of the present embodiment, the range within which a view angle characteristic can be assured can be expanded to a range of 90 degrees in the maximum. Consequently, it can be recognized that a wider view angle characteristic can be assured.

With the present embodiment, by further providing a positive type C plate on the liquid crystal layer side, a view angle characteristic of an increased width from that in the first embodiment can be assured.

Further, by using this C plate as an overcoat layer for a color filter, a phase difference plate can be produced with the offset of the color filter flattened.

Further, by using the C plate as the overcoat layer of the color filter to produce a phase difference plate in this manner, deterioration of various characteristics by a dispersion of the thicknesswise direction of the phase difference plate can be prevented.

Furthermore, it is possible to set the film thickness of the phase difference plate so as to be smaller in the transmissive display portion to further optimize the film thickness of the phase difference plate.

### Third Embodiment

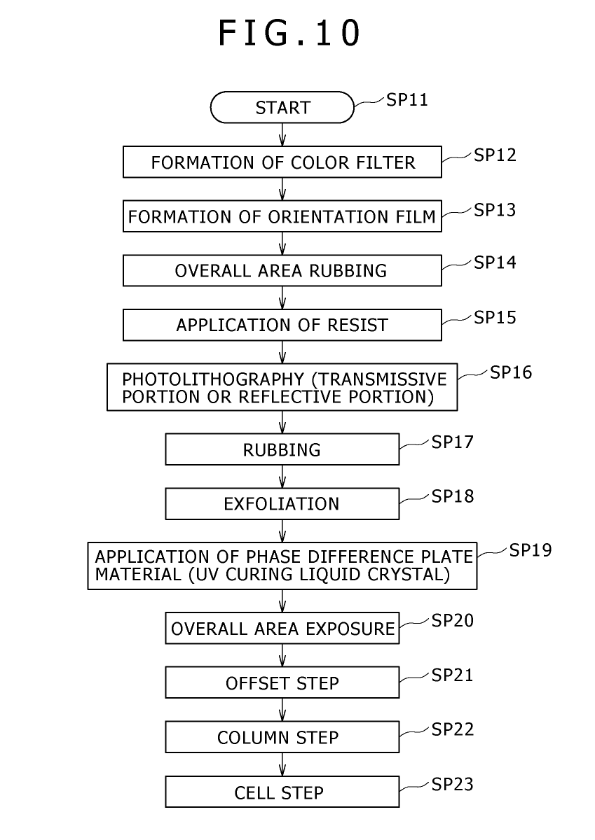

FIG. 10 illustrates a fabrication process of a CF substrate including a phase difference plate in a liquid crystal display panel of a third embodiment of the present invention in contrast with FIG. 5. The liquid crystal display panel of the present embodiment is configured similarly to the liquid crystal display panels of the first and second embodiments except that the phase difference plate is produced by a process illustrated in FIG. 10 in place of the process illustrated in FIG. 5.

In the present embodiment, an orientation film to be used for production of the phase difference plate is divisionally oriented by a mask rubbing method. In particular, referring to FIG. 10, first at step SP12 of the fabrication process of the CF substrate 3, the color filter 15 is produced on the transparent insulating substrate 13. It is to be noted that, in the configuration corresponding to the second example, a C plate 23 is produced further. Then at step SP13, an orientation film material is applied and then hardened.

Then, in the CF substrate 3, at the subsequent step SP14, the orientation property is provided in a direction corresponding to the direction of the optical axis of the phase difference plate 16 in the transmissive display portion AR1 or the reflective display portion AR2 over the overall area of the orientation film by a rubbing method. Then at step SP15, a resist material is applied, and then at step SP16, the resist material is selectively exposed and developed by photolithography, and the transmissive display portion AR1 or the reflective display portion AR2 is masked with the resist film.

In the CF substrate 3, at step SP17, the orientation film is processed by a rubbing method so that the orientation property is applied in an orientation direction corresponding to the direction of the optical axis of the phase difference plate 16 in the reflective display portion AR2 or the transmissive display portion AR1. Further, at step SP18, the resist film is exfoliated, and then at step SP19, a phase difference plate material is applied. Then at step SP20, ultraviolet rays are irradiated upon the overall face of the phase difference plate material to harden the phase difference plate material thereby to produce the phase difference plate 16. Then, in the CF substrate 3, the offset 17 is produced and then the orientation film 18 is produced at an offset step of step SP21. Further, at a column step of step SP22, a configuration for gap setting between the orientation film 18 and the TFT substrate 2 is produced. Then at a cell step of step SP23, the CF substrate 3 is integrated with the TFT substrate 2.

Also where the phase difference plate is produced by a rubbing method as in the present embodiment, similar effects to those achieved by the first and second embodiments can be achieved.

### Fourth Embodiment

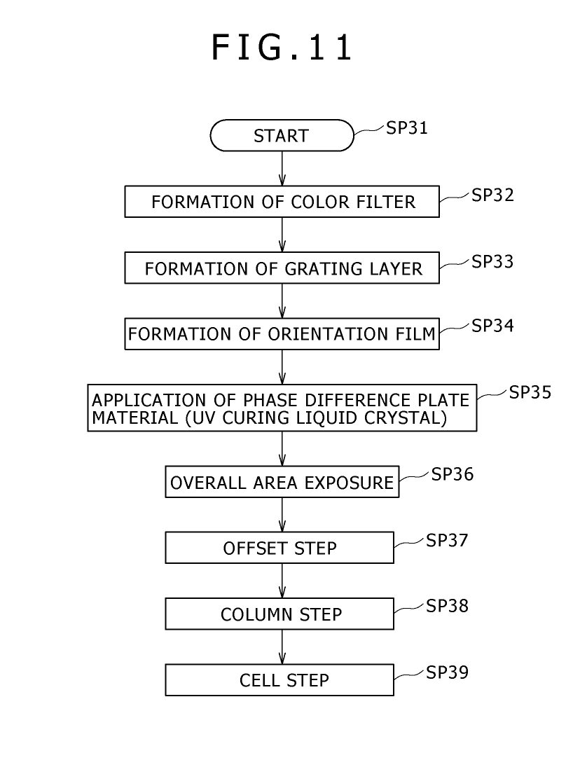

FIG. 11 illustrates a production process of a CF substrate including a phase difference plate in a liquid crystal display panel of a fourth embodiment of the present invention in contrast with FIGS. 5 and 10. The liquid crystal display panel of the present embodiment is configured similarly to the liquid crystal display panels of the first and second embodiments except that the phase difference plate is produced by a process illustrated in FIG. 11 in place of the processes illustrated in FIGS. 5 and 10.

In the present embodiment, a face for producing an orientation film to be used for production of a phase difference plate is formed in a grooved shape and the orientation film is formed in the grooved shape such that an orientation property is applied to the orientation film to produce the phase difference plate. The grooved shape here is a shape wherein a groove extending in a predetermined direction is formed repetitively in a direction perpendicular to the extending direction. Further, each groove has such a sectional shape which is symmetrical with respect to the center at the vertex thereof as, for example, a substantially arcuate sectional shape and has a ratio of the pitch and the height which is lower than 1, for example, 0.2.

To the grooved shape having such a small depth, an orientation film material such as a polyimide-based material used popularly is applied, and then the orientation film material is baked into a film. Consequently, an orientation film of the orientation property of a sufficient anchoring strength wherein high molecular chains in the orientation film are arranged to a direction perpendicular to the extending direction of the grooves.

As a result, in the CF substrate 3, the color filter 15 is produced on the transparent insulating substrate 13 at step SP32 of the production step. It is to be noted that, in the configuration corresponding to the second embodiment, the C plate 23 is produced further. Then, in the CF substrate 3, at step SP33, the side face of the color filter 15 or C plate 23 adjacent the liquid crystal layer 4 is formed into a grooved shape by an etching process, and consequently, a groove shape is formed on the production face for an orientation film. It is to be noted that, instead, the surface of the transparent insulating substrate 13 is worked into a grooved shape to produce a groove shape on the face for producing an orientation film. In the CF substrate 3, the extending direction of the grooves is set in the transmissive display portion AR1 and the reflective display portion AR2 so as to correspond to the direction of the optical axis of the phase difference plate described hereinabove with reference to FIG. 4 to form a grooved shape.

Then, at step S34, in the CF substrate 3, an orientation film material is applied and then hardened by baking thereby to produce an orientation film to which an orientation property is provided in a direction perpendicular to the extending direction of the grooves. Then, at step SP35, in the CF substrate 3, a phase difference plate material is applied, and then at step SP36, ultraviolet rays are irradiated upon the overall face of the phase difference plate material to harden the phase difference plate material thereby to produce the phase difference plate 16. Then, in the CF substrate 3, the offset 17 is produced at an offset step of step SP37 and then the orientation film 18 is produced. Then, at a column step of step SP38, a configuration for gap setting between the CF substrate 3 and the TFT substrate 2 is produced. Then at a succeeding cell step of step SP39, the CF substrate 3 is integrated with the TFT substrate 2.

Also where the face for forming an orientation film is formed in a grooved shape to produce a phase difference plate as in the present embodiment, similar effects to those achieved by the first and second embodiments can be achieved.

### Fifth Embodiment

In the present fifth embodiment, a phase difference plate is produced from a photosensitive resist obtained by mixing liquid crystal polymer which is phase difference plate material used in the embodiments described hereinabove and an orientation film material provided on the phase difference plate. The liquid crystal display apparatus of the present embodiment is similar to those of the first and second embodiments except that the configuration relating to the phase difference plate is different.

In the present embodiment, in a state wherein the photosensitive resist is applied, the polarization plane is changed over to carry out exposure processes for the transmissive display portion and the reflective display portion using ultraviolet rays thereby to orient the photosensitive resist direction to set the optical axis of the phase difference plate.

If photosensitive resist produced by mixing phase difference plate material and orientation film material to be provided on the phase difference plate is applied and then hardened by ultraviolet rays to produce a phase difference plate as in the present embodiment, then a liquid crystal display apparatus can be produced by a process simpler and easier than those of the first and second embodiment described above and similar effects to those of the first and second embodiment described hereinabove can be achieved.

### Sixth Embodiment

In the present embodiment, discotic liquid crystal is used to produce a phase difference plate which functions also as a C plate. The liquid crystal display apparatus of the present embodiment is configured similarly to the liquid crystal display apparatus of the first embodiment except that it is different in configuration relating to the phase difference plate.

In particular, in the liquid crystal display panel of the present embodiment, after a color filter and an overcoat layer are formed on a transparent insulating substrate, an orientation film for setting an optical axis of the phase difference plate is produced. For the production method of the orientation film, any one of the technique of the first to third embodiments described above can be applied. Thereafter, liquid crystal polymer of discotic liquid crystal is applied and is then hardened thereby to produce a phase difference plate. In the present liquid crystal display panel, an offset and an orientation film are subsequently formed to produce a CF substrate. It is to be noted that, where it is possible to achieve sufficient orientation for practical use, the technique described hereinabove in connection to the fifth embodiment can be applied to omit the production step of an orientation film.

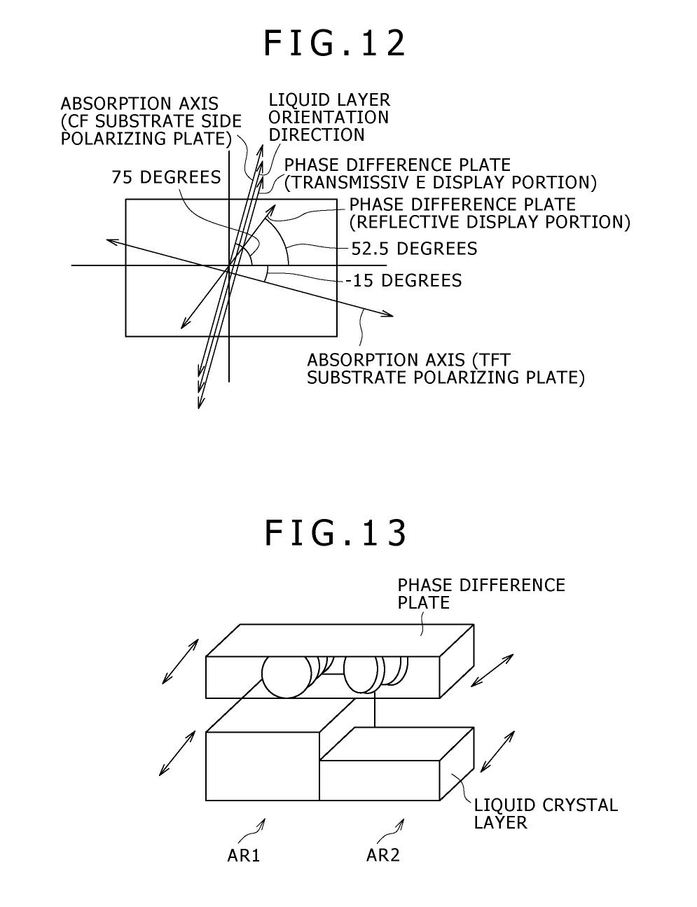

FIG. 12 illustrates operation of the phase difference plate formed using discotic liquid crystal, and FIG. 13 shows an optical configuration of the liquid crystal display panel. The phase difference plate is set such that, in the transmissive display portion, the direction of the absorption axis of the polarization plate adjacent the TFT substrate and the direction of the optical axis of the polarizing plate adjacent the TFT substrate coincide with each other. Further, in the reflective display portion, the optical axis is set such that it defines an angle of 22.5 degrees with respect to the direction of the optical axis of the transmissive display portion.

Consequently, the phase difference plate operates such that, in the transmissive display portion, no phase difference appears in the front direction while, in the reflective display portion, a phase difference appears, and besides functions as a C plate of the positive type thereby to increase the angle of view.

With the present embodiment, by producing a phase difference plate of discotic liquid crystal, the phase difference plate functions also as a C plate. Consequently, similar effects to those of the embodiments described hereinabove can be achieved by a simple configuration.

### Seventh Embodiment

In the present embodiment, the positions of the phase difference plate and the color filter are exchanged for each other to produce a CF substrate. Consequently, in the liquid crystal display panel of the present embodiment, after the phase difference plate is produced on a transparent insulating substrate, the color filter is produced, and then an offset is produced.

In the present embodiment, by producing the phase plate first, the dispersion of the phase difference plate in the thicknesswise direction can be reduced. Accordingly, characteristic deterioration by the dispersion in the thicknesswise direction can be reduced.

### Eighth Embodiment

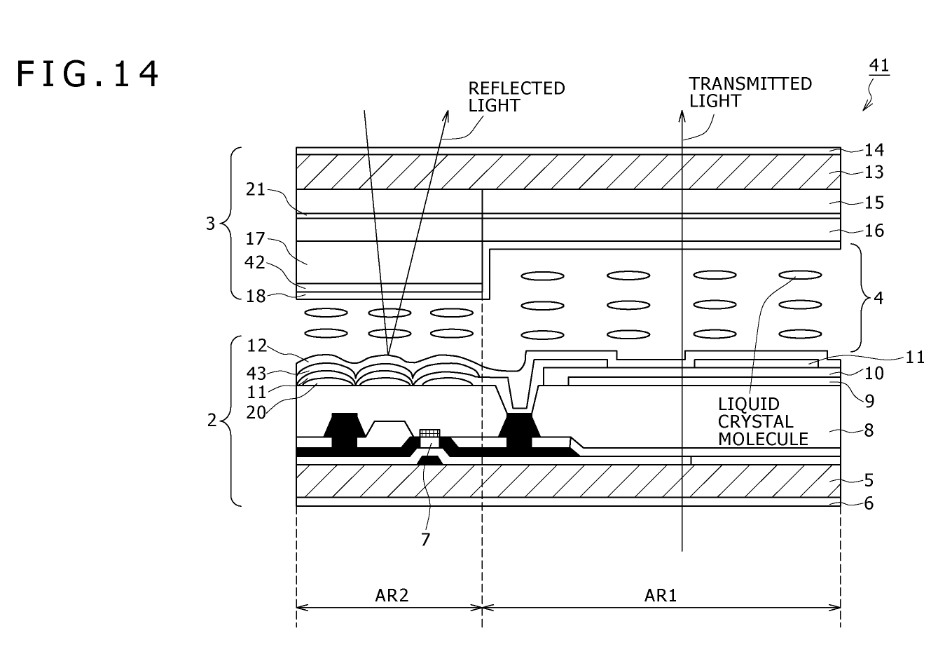

FIG. 14 shows a liquid crystal display panel applied to a liquid crystal display apparatus of an eighth embodiment of the present invention. Referring to FIG. 14, a liquid crystal display panel 41 of the present embodiment is configured substantially similarly to those of the embodiments described hereinabove except that the reflective display portion AR2 is formed from an electrically controlled birefringence mode. Thus, description of common components to those of the embodiments described above is omitted herein to avoid redundancy. Thus, in the reflective display portion AR2 of the liquid crystal display panel 41, a common electrode 42 and a pixel electrode 43 are provided such that the liquid crystal layer 4 is sandwiched by them.

In particular, in the reflective display portion AR2, the common electrode 42 is provided on the orientation film 18 adjacent the transparent insulating substrate 13 of the CF substrate 3 and connected to the common electrode 9 of the transmissive display portion AR1. In the reflective display portion AR2, the TFT substrate 2 includes the reflecting electrode 43 provided on the orientation film 12 adjacent the transparent insulating substrate 5, and the reflecting electrode 43 is connected to the pixel electrode 11 of the transmissive display portion AR1. It is to be noted that naturally the reflective display portion AR2 is optically designed so as to correspond to the transmissive display portion AR1.

If the reflective display portion is formed as an electrically controlled birefringence mode as in the present embodiment, then the reflection factor of the reflective display portion can be increased while the transmissive display portion can be formed as an FFS mode of the angle of view.

### Ninth Embodiment

It is to be noted that, while, in the embodiments described above, the orientation directions of the liquid crystal layer in the transmissive display portion and the reflective display portion are same as each other, the present invention is not limited to this. In particular, the present invention can be applied widely also where the orientation direction of an orientation film is made different between the transmissive display portion and the reflective display portion by divisional orientation so that the orientation direction of the liquid crystal layer is made different between the transmissive display portion and the reflective display portion.

Further, while, in the embodiments described above, an offset is formed such that the cell gap is made different between the transmissive display portion and the reflective display portion, the present invention is not limited to this. In particular, the present invention can be applied widely also where the cell gap is equal between the transmissive display portion and the reflective display portion.

Further, while, in the embodiments described above, the present invention is applied to a liquid crystal display apparatus of the FFS mode wherein a pixel electrode has a slit shape, the present invention is not limited to this. In particular, the present invention can be applied widely also to various liquid crystal display apparatus wherein liquid crystal molecules in a horizontal direction are switched such as a liquid crystal display apparatus of the IPS system wherein a pixel electrode and a common electrode are formed in a comb shape.

It should be understood by those skilled in the art that various modifications, combinations, sub-combinations and alterations may occur depending on design requirements and other factor in so far as they are within the scope of the appended claims or the equivalents thereof.

What is claimed is:

1. A liquid crystal display apparatus, comprising:
first and second substrates having first and second polarizing plates, respectively;
a liquid crystal layer sandwiched between said first and second substrates;
an electrode provided on said first substrate for applying an electric field parallel to a face of said first substrate to said liquid crystal layer to drive liquid crystal molecules of said liquid crystal layer;
a pixel having a reflective display portion and a transmissive display portion; and
a phase difference plate provided on a face of said second substrate adjacent said liquid crystal layer such that no phase difference is generated in a front direction in the transmissive display portion but a phase difference is generated in the reflective display portion.

2. The liquid crystal display apparatus according to claim 1, wherein the phase difference in the reflective display portion of said phase difference plate is λ/2.

3. The liquid crystal display apparatus according to claim 1, wherein the transmissive display portion has an optical axis whose direction coincides with the direction of an absorption axis of said first or second polarizing plate.

4. The liquid crystal display apparatus according to claim 1, wherein the transmissive display portion of said phase difference plate has an optical axis whose direction is set so as to be perpendicular to an orientation direction of said liquid crystal layer when no electric field is applied.

5. The liquid crystal display apparatus according to claim 1, wherein said second substrate has a positive C plate provided on a side adjacent said liquid crystal layer and having homeotropic orientation.

6. The liquid crystal display apparatus according to claim 5, wherein said positive C plate is an overcoat layer formed on said second substrate.

7. The liquid crystal display apparatus according to claim 1, wherein said second substrate has a positive C plate provided on a side adjacent said liquid crystal layer and having homeotropic orientation, and said phase difference plate is provided on a face of said positive C plate adjacent said liquid crystal layer.

8. The liquid crystal display apparatus according to claim 1, wherein said second substrate has a color filter provided on a face adjacent said liquid crystal layer, and said positive C plate and said phase difference plate are provided successively on a face of said color filter adjacent said liquid crystal layer such that the offset by said color filter is flattened by said positive C plate.

9. The liquid crystal display apparatus according to claim 1, wherein said second substrate includes a color filter provided on a face of said phase difference plate adjacent said liquid crystal layer.

10. The liquid crystal display apparatus according to claim 1, wherein said liquid crystal display apparatus is of the normally black type wherein black is displayed in a state wherein the electric field is not applied to said liquid crystal layer.

11. The liquid crystal display apparatus according to claim 1, wherein said phase difference plate is formed so as to have a thickness which is smaller at the transmissive display portion than at the reflective display portion.

12. The liquid crystal display apparatus according to claim 1, wherein said phase difference plate is produced by applying a material for said phase difference plate to orientation films which are individually oriented in predetermined directions in the transmissive display portion and the reflective display portion and then hardening the material, and said orientation films have orientation properties individually set to different directions in the transmissive display portion and the reflective display portion.

13. The liquid crystal display apparatus according to claim 1, wherein said phase difference plate is produced by applying a material for said phase difference plate to orientation films which are individually oriented in predetermined directions in the transmissive display portion and the reflective display portion and then hardening the material, and said orientation films have orientation directions individually set to predetermined directions in the transmissive display portion and the reflective display portion.

14. The liquid crystal display apparatus according to claim 1, wherein said phase difference plate is produced by applying a photosensitive resist and then irradiating ultraviolet rays of a predetermined polarization plane to orient the photosensitive resist to predetermined directions in the transmissive display portion and the reflective display portion.

15. The liquid crystal display apparatus according to claim 1, wherein said phase difference plate is produced by applying a material for said phase difference plate to orientation films which are individually oriented in predetermined directions in the transmissive display portion and the reflective display portion and then hardening the material, and each of said orientation films has an orientation property provided by a grooved shape of a face for forming the orientation film.

16. The liquid crystal display apparatus according to claim 1, wherein said phase difference plate is produced from discotic liquid crystal.

17. A liquid crystal display apparatus, comprising:
first and second substrates having first and second polarizing plates, respectively;
a liquid crystal layer sandwiched between said first and second substrates;
a pixel having a reflective display portion and a transmissive display portion; and
a phase difference plate provided on a face of said second substrate adjacent said liquid crystal layer such that no phase difference is generated in a front direction in the transmissive display portion but a phase difference is generated in the reflective display portion;
wherein the transmissive display portion is configured such that, from an electrode provided on said first substrate, an electric field parallel to a face of said substrates is applied to said liquid crystal layer to drive liquid crystal molecules of said liquid crystal layer, and
the reflective display portion is driven in an electrically controlled birefringence mode through a pixel electrode provided on said first substrate and a common electrode provided on said second substrate.
